(19) United States
(12) Patent Application Publication
(10) Pub. No.: US 2015/0113364 A1
(43) Pub. Date: Apr. 23, 2015

(54) SYSTEM AND METHOD FOR GENERATING AN AUDIO-ANIMATED DOCUMENT

(71) Applicant: Tata Consultancy Services Limited, Mumbai (IN)

(72) Inventors: Vidya Sagar THATIPARTHI, Chennai (IN); Aravind Ravi, Chennai (IN)

(73) Assignee: Tata Consultancy Services Limited

(21) Appl. No.: 14/059,358

(22) Filed: Oct. 21, 2013

(51) Int. Cl. G06F 17/21; G10L 13/02; G06F 17/27; G06F 17/22

(52) U.S. Cl. CPC G06F 17/218; G06F 17/2247; G10L 13/02; G06F 17/2765
USPC 715/202

(57) ABSTRACT

The present disclosure relates to document generation, and more particularly to a system and method for generating an audio-animated document. In one embodiment, a method for generating an audio-animated document is disclosed, comprising: obtaining an extensible markup language (XML) file from a database, wherein the XML file comprises data corresponding to transactional activities over a time interval; identifying a set of phrases and one or more images from a resource library based on the XML file; generating a playback text using the set of phrases, the one or more images, the data, and a set of rules; providing one or more audio files corresponding to the playback text; and generating the audio-animated document based on the data, the one or more images, and the one or more audio files.

### TECHNICAL FIELD

The present disclosure relates to document generation, and more particularly to a system and method for generating an audio-animated document.

### BACKGROUND

Despite that information technologies have become widely available these days, some industries or sectors, such as banking, financial services and insurance (BFSI) industries, are still incurring costs on printing paper bank statements or credit-card statements. According to Forrester Research, only 24% of the bank statements are being delivered electronically today, while 76% of the bank statements are still being delivered as printed paper documents.

With the advent of various software tools, electronic documents can be conveniently distributed to the customers in an effective, highly secured, and efficient manner using electronic communication networks. The various software tools may also enable the BFSI industries and/or sectors to follow the trend to deliver the bank statements to the customers electronically by using the electronic communication networks. Delivering bank statements electronically can not only encourage customers to follow the go-green initiatives but also help reducing the printing costs.

Moreover, various new features have been incorporated into electronic documents, such as bank statements. These new features may also encourage customers to choose to receive electronic bank statements. As an example, one of the new features is the “Read Out Loud” feature included in portable document format (PDF) files provided by Adobe Reader®. The “Read Out Loud” feature allows an electronic device, such as a desktop computer, a laptop computer, a smartphone, an e-book reader, and a tablet computer, to read contents, such as texts, in a PDF document to the user of the PDF file in an audible manner. For a PDF document that contains largely texts, the “Read Out Loud” feature can provide audible output of the PDF document in a sequential manner.

On the other hand, while electronic bank statements can allow the bank customers to review and track the transaction history through textual contents embedded in the electronic bank statements, electronic bank statements cannot be readily provided in an audible manner by, for example, the “Read Out Loud” feature. Furthermore, electronic bank statements also do not usually include any audio or image contents or features.

### SUMMARY

Before the present systems and methods, are described, it is appreciated that this application is not limited to the particular systems, and methodologies described, as there can be multiple possible embodiments which are not expressly illustrated in the present disclosures. It is also appreciated that the terminology used in the description is for the purpose of describing the particular versions or embodiments only, and is not intended to limit the scope of the present application. This summary is provided to introduce concepts related to systems and methods for generating an audio-animated document for a user and the concepts are further described below in the detailed description. This summary is not intended to identify essential features of the claimed subject matter nor is it intended for use in determining or limiting the scope of the claimed subject matter.

In one embodiment, a method for generating an audio-animated document is disclosed. The method comprises obtaining an extensible markup language (XML) file from a database, wherein the XML file comprises data corresponding to transactional activities over a time interval; identifying a set of phrases and one or more images from a resource library based on the XML file; generating a playback text using the set of phrases, the one or more images, the data, and a set of rules; providing one or more audio files corresponding to the playback text; and generating the audio-animated document based on the data, the one or more images, and the one or more audio files.

In one embodiment, a system for generating an audio-animated document is disclosed. The system comprises a processor; and a memory storing processor-executable instructions comprising instructions to: obtain an extensible markup language (XML) file from a database, wherein the XML file comprises data corresponding to transactional activities over a pre-defined time interval; identify a set of phrases and one or more images from a resource library based on the XML file; generate a playback text using the set of phrases, the one or more images, the data, and a set of rules; provide one or more audio files corresponding to the playback text; and generate the audio-animated document based on the data, the one or more images, and the one or more audio files.

In one embodiment, a non-transitory computer program product having embodied thereon computer program instructions for generating an audio-animated document is disclosed. The instructions comprises instructions for: obtaining an extensible markup language (XML) file from a database, wherein the XML file comprises data corresponding to transactional activities over a time interval; identifying a set of phrases and one or more images from a resource library based on the XML file; generating a playback text using the set of phrases, the one or more images, the data, and a set of rules; providing one or more audio files corresponding to the playback text; and generating the audio-animated document based on the data, the one or more images, and the one or more audio files.

### BRIEF DESCRIPTION OF THE DRAWINGS

The accompanying drawings, which are incorporated in and constitute a part of this disclosure, illustrate exemplary embodiments and, together with the description, serve to explain the disclosed principles.

The detailed description is described with reference to the accompanying figures. In the figures, the left-most digit(s) of a reference number identifies the Fig. in which the reference number first appears. The same numbers are used throughout the drawings to refer like features and components.

FIG. 1 illustrates a network implementation of a system for generating an audio-animated document, in accordance with an embodiment of the present subject matter.

FIG. 2 illustrates the system, in accordance with an embodiment of the present subject matter.

FIG. 3 illustrates various modules of the system, in accordance with an embodiment of the present subject matter.

FIG. 4 illustrates a method for generating an audio-animated document for a user, in accordance with an embodiment of the present subject matter.

### DETAILED DESCRIPTION

Exemplary embodiments are described with reference to the accompanying drawings. While examples and features of disclosed principles are described herein, modifications, adaptations, and other implementations are possible without departing from the spirit and scope of the disclosed embodiments. It is intended that the following detailed description be considered as exemplary only, with the true scope and spirit being indicated by the following claims.

Various modifications to the embodiments will be readily apparent to those skilled in the art and the generic principles herein may be applied to other embodiments. However, it is readily appreciated that the present disclosure is not intended to be limited to the embodiments illustrated, but is to be accorded the widest scope consistent with the principles and features described herein.

Systems and methods for generating an audio-animated document for a user are described. The audio-animated document may be at least one of a credit-card statement, bank statement, account statement or summary of financial transactions, and any other statements and summaries. The audio-animated document may be generated in at least one of Hypertext Markup Language (HTML) format, a Portable Document Format (PDF) format, a Microsoft Word format, and any other desire format.

The present subject matter discloses examples of effective and efficient methods for generating an audio-animated document. In some embodiments, the method for generating the audio-animated document may include obtaining data from a database. The data may be associated with one or more transactional activities performed by the user over a pre-defined time interval. The one or more transactional activities may comprise at least one of financial transactions, social-media transactions, and web-based transactions, and any other type of transactions that is desired. After obtaining the data, a set of pre-defined phrases and one or more images may be identified from a resource library based on the data obtained from the XML file.

After the identification, the set of pre-defined phrases and the one or more images, the set of pre-defined phrases, and the data may be processed to generate a playback text. In some embodiments, a Text-to-Speech (TTS) converter and/or speech synthesis techniques may be used to convert the playback text to one or more audio files. The one or more audio files and the one or more images can represent an analytical summary of the one or more transactional activities performed by the user over a pre-defined time interval.

After providing the one or more audio files, the audio-animated document may be generated based upon the data, the one or more images, and the one or more audio files. While aspects of described system and method for generating the audio-animated document may be implemented in any computing systems, environments, and/or configurations, the embodiments are described in the context of the following exemplary system.

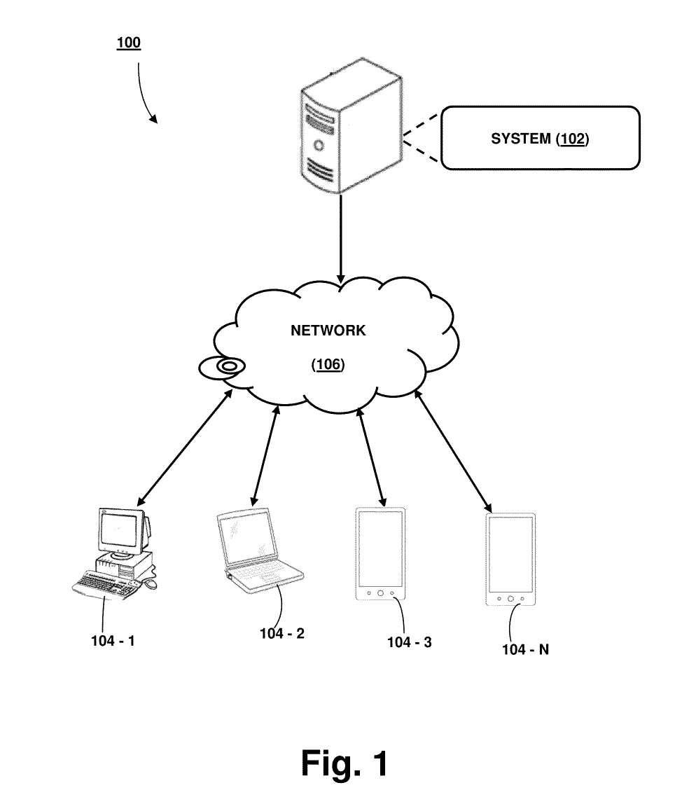

Referring now to FIG. 1, a network implementation 100 may comprise a system 102 for generating an audio-animated document for a user, in accordance with some embodiments of the present subject matter. The system 102 may obtain, such as extract, an XML file from a database. The XML file may comprise data corresponding to transactional activities of the user over a pre-defined time interval. Based on the XML file, the system 102 may further identify a set of pre-defined phrases and one or more images from a resource library. After identifying the set of pre-defined phrases and the one or more images, the system 102 may processes the set of pre-defined phrases, the one or more images, and the data in order to generate a playback text. In some embodiments, the system 102 may provide one or more audio files by, for example, converting the playback text into the audio files. After providing the one or more audio files, the system 102 may further generate the audio-animated document based up the data, the one or more images, and the one or more audio files.

In some embodiments, the audio-animated document may comprise one or more placeholders. The system 102 may link the one or more placeholders with the data, at least one image of the one or more images, and at least one audio file of the one or more audio files. Based on the linking, the system 102 may further enable a user to play the at least one audio file of the one or more audio files and the one or more images after the system 102 receiving the user's selection of a placeholder from the one or more placeholders.

In some embodiments, the audio-animated document may further be linked with a textual document wherein the textual document may be a bank statement listing one or more transactions performed by the user over a pre-defined time interval. The one or more transactions listed in the textual document may be in textual form.

In some embodiments, the system 102 may be a laptop computer, a desktop computer, a notebook, a workstation, a mainframe computer, a server, a network server, a cloud-based computing environment and the like. Moreover, the system 102 may be accessed by one or more electronic devices 104-1, 104-2 . . . 104-N (collectively referred to as devices 104 hereinafter), or applications residing on the devices 104. In some embodiments, the system 102 may comprise a cloud-based computing environment enabling remote operations of the system 102 by electronic devices (e.g., electronic devices 104) configured to execute such remote operations. Examples of the devices 104 may include, but are not limited to, a portable computer, a personal digital assistant, a handheld device, a Smartphone, an e-book reader, a tablet computer, and a workstation. The devices 104 can be communicatively coupled to the system 102 through a network 106.

In some embodiments, the network 106 may be a wireless network, a wired network, or a combination thereof. The network 106 can be implemented as one of the different types of networks, such as intranet, local area network (LAN), wide area network (WAN), the internet, and the like. The network 106 may either be a dedicated network or a shared network. A shared network represents an association of different types of networks that may use a variety of protocols, such as Hypertext Transfer Protocol (HTTP), Transmission Control Protocol/Internet Protocol (TCP/IP), Wireless Application Protocol (WAP), and the like, to communicate with one another. Further, the network 106 may include a variety of network devices, including routers, bridges, servers, computing devices, storage devices, and the like.

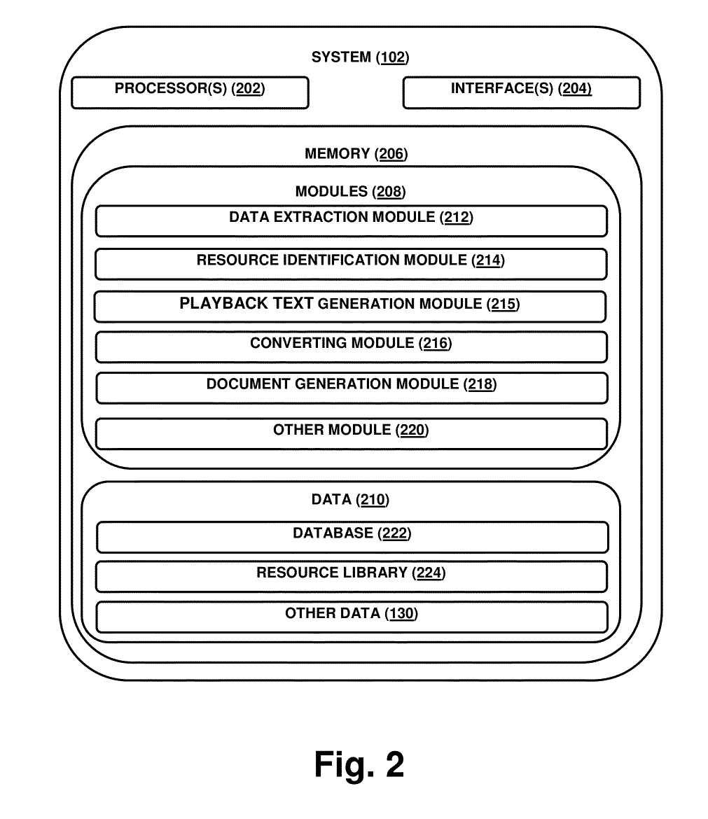

Referring now to FIG. 2, the system 102 is illustrated in accordance with some embodiments of the present disclosure. In some embodiments, the system 102 may include one or more processor(s) 202, one or more input/output (I/O) interface(s) 204, and a memory 206. The processor(s) 202 may be implemented as one or more microprocessors, microcomputers, microcontrollers, digital signal processors, central processing units, state machines, logic circuitries, and/or any devices that manipulate signals based on operational instructions. Among other capabilities, the processor(s) 202 may be configured to fetch and execute computer-readable instructions stored in the memory 206.

The I/O interface(s) 204 may include a variety of software and hardware interfaces, such as a web interface, a graphical user interface, and the like. The I/O interface(s) 204 may allow the system 102 to interact with the user directly or through the devices 104. Further, the I/O interface(s) 204 may enable the system 102 to communicate with other computing devices, such as web servers and external data servers (not shown). The I/O interface(s) 204 can enable multiple communications within a wide variety of networks and protocol types, including wired networks, such as LAN, cable, etc., and wireless networks, such as WLAN, cellular, or satellite. The I/O interface(s) 204 may include one or more ports configured to connecting a number of devices to one another or to another server.

The memory 206 may include any computer-readable medium or computer program product including, for example, volatile memory, such as static random access memory (SRAM) and dynamic random access memory (DRAM), and/or non-volatile memory, such as read only memory (ROM), erasable programmable ROM, flash memories, hard disks, optical disks, and magnetic tapes. The memory 206 may include modules 208 and data 210.

The modules 208 may include routines, programs, objects, components, data structures, etc., which perform particular tasks or implement particular abstract data types. In one implementation, the modules 208 may include a data extraction module 212, a resource identification module 214, a playback text generation module 215, a converting module 216, a document generation module 218, and other modules 220. The other modules 220 may include programs or coded instructions that supplement applications and functions of the system 102. The modules 208 described herein may also be implemented as software modules that may be executed in the cloud-based computing environment of the system 102.

The data 210, amongst other things, serves as a repository for storing data processed, received, and generated by one or more of the modules 208. The data 210 may also include a database 222, a resource library 224, and other data 130. The other data 130 may include data generated as a result of the execution of one or more modules in the other module 220.

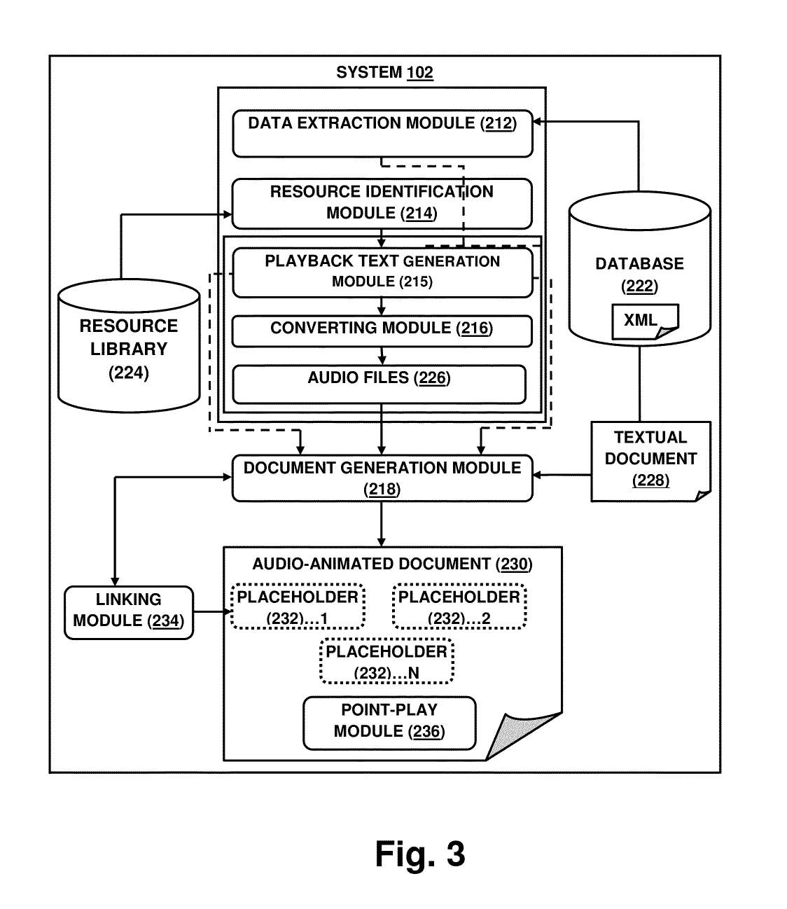

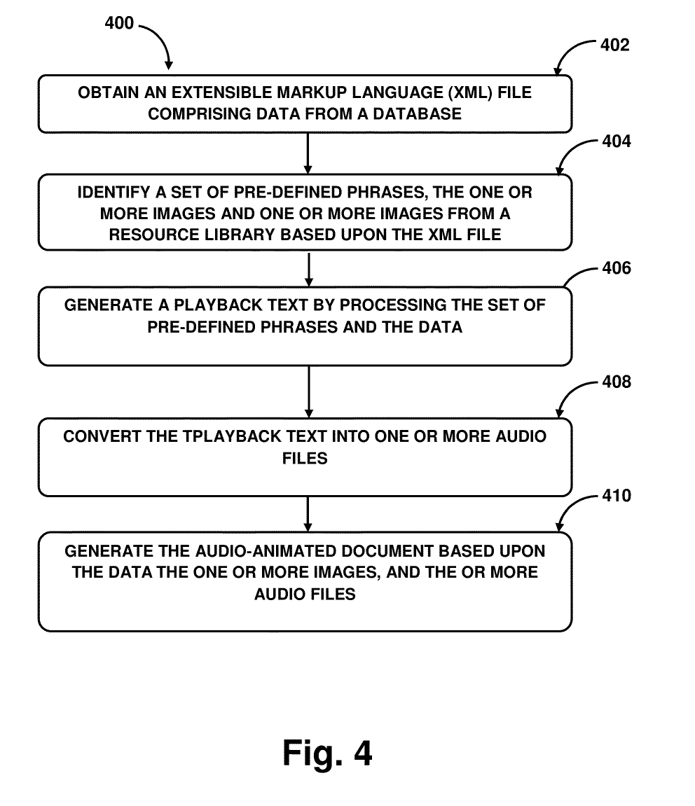

In some embodiments, a user may use devices 104 to access the system 102 via the I/O interface(s) 204. In particular, the user may first register themselves, such as log on to the system 102 using the I/O interface(s) 204, in order to use the system 102. The operation of the system 102 is explained in detail in FIGS. 3 and 4 below. The system 102 may generate an audio-animated document for the user. In order to generate the audio-animated document, the system 102 may obtain, such as retrieve, an extensible markup language (XML) file from a database 222.

Referring to FIG. 3, various modules of the system 102 are illustrated, in accordance with an embodiment of the present subject matter. The system 102 may generate an audio-animated document 230 for a user. In some embodiments, the audio-animated document 230 may be generated based on one or more transactional activities associated with the user over pre-defined time interval. The one or more transactional activities may comprise at least one of financial transactions, social-media transactions, and web-based transactions. Based on the one or more transactional activities associated with the user, the system 102 may generate the audio-animated document 230, such as a credit-card statement, a bank statement, a account statement or a summary of financial transactions. The audio-animated document 230 may be generated in at least one of Hypertext Markup Language (HTML) format, a Portable Document Format (PDF) format, and any other desired format.

In some embodiments, the system 102 may be communicatively connected to a database 222, such as a cloud based database, through the network 106. The system 102 may comprise a memory 206 coupled to processor(s) 202 for generating the audio-animated document 230. The memory 206 may comprise a plurality of modules that are configured to generate the audio-animated document 230. In some embodiments, the system 102 may be independent of the specific technology platform used to generate the audio-animated document 230. For example, the plurality of modules may be configured to be executed on the technology platforms including operating systems such as Windows, Android, iOS, Linux, or any other operating systems. According to the present disclosure, the plurality of modules may comprise a data extraction module 212, a resource identification module 214, a playback text generation module 215, a converting module 216, and a document generation module 218. The memory 206 may further comprise a database 222 and a resource library 224. The database 222 may be a relational database, a SQLite database, or any other lightweight relational database capable of storing data.

In some embodiments, in order to generate the audio-animated document 230, the data extraction module 212 may obtain, such as extract, an XML file from the database 222. In one aspect, the XML file may comprise the data corresponding to one or more transactional activities associated with the user over the pre-defined time interval. The XML may be a markup language that defines a set of rules for encoding data in a format that is readable by the system 102. In some embodiments, for extracting the data from the database 222, the data extraction module 212 may be configured to extract the XML file by executing at least one Structured Query Language (SQL) query on the database 222. In one aspect, the SQL query may comprise one or more parameters associated with the one or more transactional activities. After executing the SQL query, the data extraction module 212 may extract the data based on the one or more parameters of the SQL query.

In some embodiments, the data extraction module 212 may be configured to extract the data from the XML file using a pre-defined XML function such as ‘fetchXMLData’ function. The ‘fetchXMLData’ function may facilitate the data extraction module 212 to extract the data from the database 222. After extracting the data from the XML file, the data extraction module 212 may further be configured to validate the data extracted from the XML file stored in the database 222. The extracted data may be validated by using one or more validation methods, such as allowed character checks, cardinality check, check digits, consistency checks, data type checks, and limit check.

After the validation of the data, the resource identification module 214 may be configured to identify a set of pre-defined phrases and one or more images from the resource library 224 based on the data extracted from the XML file. The set of pre-defined phrases and the one or more images may be identified by using the XML file. As an example, the XML file may comprise data that are associated with corresponding XML tags. The XML tags may be associated with the one or more transactional activities. The data associated with corresponding XML tags may enable the resource identification module 214 to identify the set of pre-defined phrases and one or more images from the resource library 224. The set of pre-defined phrases may be stored in textual format. The one or more images may be stored in at least one of a JPEG, PNG, BMP, JPG, and a combination thereof.

Based on the extraction of the data and the identification of the set of pre-defined phrases and the one or more images, the playback text generation module 215 may be configured to generate a playback text by processing the set of pre-defined phrases, the one or more images, and the data. In some embodiments, the set of pre-defined phrases, the one or more images, and the data may be processed based on a set of rules. The set of rules may be defined based on the transactional activities and/or a spending/purchasing pattern of the user. Spending/purchasing patterns may or may not be the same for all the users and/or customers. As an example, a “Customer A” may be spending on air travel and lodging for a specific month. In the same month, another “Customer B” may be spending on services and merchandise. As a result, the set of rules may process “Customer A” data such that the respective pre-defined text phrase may be selected for “Customer A” corresponding to his/her spending pattern. Similarly, the set of rules may process “Customer B” data such that the respective pre-defined text phrase may be selected for “Customer B” corresponding to his/her spending pattern.

In some embodiments, the playback text generation module 215 may also concatenate or link the set of pre-defined phrases and the data corresponding to the one or more transactional activities of the user. Specifically, in the above example, the playback text generation module 215 may generate playback texts including a “Customer A Text” and a “Customer B Text” for “Customer A” and Customer B,” respectively.

After the generation of the playback text, the converting module 216 may be configured to convert the playback text into one or more audio files. In some embodiments, the one or more audio files may be converted by using a Text-to-Speech (TTS) converter and/or speech synthesis techniques. In the same example as disclosed above, the converting module 216 may convert the play back texts generated for the “Customer A” and the “Customer B” into “Customer A audio file” and “Customer B audio file”. In an embodiment, the one or more audio files may be stored in the memory 206 of the system 102. After the conversion of the playback text into the one or more audio files, the document generation module 218 may be configured to generate the audio-animated document 230 based on the data, the one or more images, and the one or more audio files. The audio-animated document 230 may comprise one or more placeholders 232-1, 232-2 . . . 232-N (collectively referred to as 232). A placeholder may be linked with a sub-set of the data, at least one image of the one or more images, and at least one audio file of the one or more audio files by using a linking module 234. The one or more placeholders 232 may also be embedded with the sub-set of the data, the at least one image of the one or more images, and at least one audio file of the one or more audio files.

In some embodiments, the document generation module 218 may trigger the execution of one or more pre-defined functions linked with the document generation module 218 and the linking module 234. For example, the one or more functions may perform their respective tasks for generating the audio-animated document 230 in portable document format (PDF) or in hypertext markup language (HTML). In one aspect, the one or more functions may comprise functions such as a “setPDFWriter,” an “embedXMLData,” a “putRichMediaAnnotation,” and a “generatePDF.” In one aspect, the setPDFWriter and the generatePDF may be associated with the document generation module 218 whereas the embedXMLData and the putRichMediaAnnotation may be associated with the linking module 234.

In an exemplary embodiment of the present disclosure, the document generation module 218 may create the PDF generator using the setPDFWriter. After the PDF generator is created, the linking module 234 may link or embed the data with the one or more placeholders 232 using the embedXMLData. The linking module 234 may further link the at least one audio file of the one or more audio files with the one or more placeholders 232 using the putRichMediaAnnotation. After the one or more audio files are linked with the one or more placeholders 232, the document generation module 218 may further generate the audio-animated document 230 in PDF format using the generatePDF. In one aspect of the present disclosure, the audio-animated document 230 may further be linked with a textual document 228. The textual document 228 may be a document listing the one or more transactional activities performed by the user over the pre-defined time interval. The one or more transactional activities listed in the textual document 228 may be in textual form.

In some embodiments, the audio-animated document 230 comprises the sub-set of the data, the at least one image of the one or more images, the at least one audio file of the one or more audio files linked with the one or more placeholders 232. The audio-animated document 230 can represent an analytical summary of the one or more transactional activities performed by the user over a pre-determined time interval. In one aspect, the analytical summary may enable the user to view the data corresponding to the one or more transactional activities of the user in an audio format and/or in an image format. The data may be audio enabled with customized background messages for each statement having automatic top/down play or dynamic play. Moreover, while the audio is being played, the images may be displayed as static images or animated images that can be zoomed in/out using image animation techniques. In some embodiments, the audio may be played using the at least one audio file of the one or more audio files, while the image may be displayed using the at least one image of the one or more images. In one aspect, the images may comprise at least one of a pie chart, a bar chart, a line chart, an advertisement, a marketing or promotional campaign.

In some embodiments, when the user accesses the audio-animated document 230, the system 102 may enable the user to playback the at least one audio file of the one or more audio files linked with the one or more placeholders 232. In some embodiments, the at least one audio file of the one or more audio files may be played in a sequence based on the one or more placeholders. In order to playback a specific audio file of the one or more audio files, the point-play module 236 may be configured to playback the at least one audio file associated with a specific placeholder selected from the one or more placeholders 232.

In some embodiments, the aforementioned exemplary method and system may be used for generating a bank statement providing a summary of banking transactions performed by a user, such as a bank customer. The banking transactions performed by the bank customer may be embedded in the XML file that is stored in the database 222. In order to generate an audio-animated bank statement, (e.g., audio-animated document 230), the data extraction module 212 may be configured to extract the banking transactions performed by the bank customer from the XML file. In some embodiments, the banking transactions may also be validated by using one or more validation methods, such as allowed character checks, cardinality check, check digits, consistency checks, data type checks, and limit check.

After the banking transactions are extracted, the resource identification module 214 may be configured to identify pre-defined phrases and images based on a spending pattern of the bank customer over the pre-defined time interval. The images may relate to various commercial products' brands that are associated with enterprises/vendors having service agreements with the bank. The images may be configured and/or customized according to requirements of each enterprise/vendor. Further, the pre-defined phrases may be a standard text displayed for greeting the bank customer. For example, the pre-defined phrase may be a “hello message”. Further, the pre-defined phrases may comprise standard texts associated with the banking transactions including account, balance, debit, and credit. In one aspect, the resource identification module 214 may be configured to select the images by implementing the set of rules. The set of rules may be associated to the transactional activities or spending/purchasing pattern of the user.

As an example, a bank customer may have performed a banking transaction of “Rupees 6000”, a pre-defined phrase corresponding to the banking transaction of “Rupees 6000” identified as “spent an amount of” according to the resource library. Further, the user may have performed most of the banking transactions on booking of the air tickets. The resource identification module 214 may then identify, from the resource library, an image providing various discounts of booking of air tickets offered by a plurality of airlines. In some embodiments, the images associated with the promotional offer of the airlines may be displayed when the bank customer spent more than a certain amount, such as Rupees5000, during the pre-defined time interval.

Based on the identification of the pre-defined phrase and the promotional image, the playback text generation module 215 may be configured to generate a playback text comprising the concatenation or linking of the pre-defined phrase and the banking transactions. As an example, the playback text may comprise “spent an amount of Rupees 6000”. After the playback text is generated, the converting module 216 may be configured to convert the playback text “spent an amount of Rupees 6000” into an audio file. The document generation module 218 may be configured to generate the audio-animated bank statement based on the banking transaction “spent an amount of Rupees 6000,” the audio file “spent an amount of Rupees 6000,” and the promotional image “discounts offered on the booking of the air tickets”.

Exemplary embodiments discussed above may provide certain advantages. Though not required to practice aspects of the disclosure, these advantages may include those provided by the following features.

Some embodiments enable a system and a method to generate an audio-animated document in an electronic format that encourages go-green initiatives and reduces the printing cost.

Some embodiments enable enables visually challenged customer to understand one or more transactional activities performed by him/her over a pre-defined time interval through an interactive analytical summary.

Some embodiments enable an effective campaign management by showing relevant campaigns while playing the audio part of the audio-animated document.

Referring now to FIG. 4, a method 400 for generating an audio-animated document is shown, in accordance with an embodiment of the present subject matter. The method 400 may be described in the general context of computer executable instructions. Generally, computer executable instructions can include routines, programs, objects, components, data structures, procedures, modules, functions, etc., that perform particular functions or implement particular abstract data types. The method 400 may also be practiced in a distributed computing environment where functions are performed by remote processing devices that are linked through a communications network. In a distributed computing environment, computer executable instructions may be located in both local and remote computer storage media, including memory storage devices.

The order in which the method 400 is described is not intended to be construed as a limitation, and any number of the described method blocks can be combined in any order to implement the method 400 or alternate methods. Additionally, individual blocks may be deleted from the method 400 without departing from the spirit and scope of the subject matter described herein. Furthermore, the method 400 can be implemented in any suitable hardware, software, firmware, or combination thereof. However, for ease of explanation, in the embodiments described below, the method 400 may be considered to be implemented as described in the system 102.

At block 402, an XML file from a database may be obtained, such as retrieved. In some embodiments, the XML file may be extracted by the data extraction module 212.

At block 404, a set of pre-defined phrases and one or more images from a resource library may be identified. In some embodiments, the set of pre-defined phrases and the one or more images may be identified by the resource identification module 214.

At block 406, the set of pre-defined phrases, the one or more images, and the data may be processed to generate a playback text based on a set of rules. In some embodiments, the playback text may be generated by using the playback text generation module 215.

At block 408, the playback text may be converted into one or more audio files. In some embodiments, the one or more audio files may be converted by using the converting module 216.

At block 410, an audio-animated document may be generated based on the data, the one or more images, and the one or more audio files. In some embodiments, the audio-animated document may be generated by using the document generation module 218.

Although implementations for methods and systems for generating the audio-animated document have been described in language specific to structural features and/or methods, it is to be understood that the appended claims are not necessarily limited to the specific features or methods described. Rather, the specific features and methods are disclosed as examples of implementations for generating the audio-animated document for the user.

We claim:

1. A method for generating an audio-animated document, the method being performed by a processor using programmed instructions stored in a memory, the method comprising:
obtaining an extensible markup language (XML) file from a database, wherein the XML file comprises data corresponding to transactional activities over a time interval;
identifying a set of phrases and one or more images from a resource library based on the XML file;
generating a playback text using the set of phrases, the one or more images, the data, and a set of rules;
providing one or more audio files corresponding to the playback text; and
generating the audio-animated document based on the data, the one or more images, and the one or more audio files.

2. The method of claim 1, wherein the audio-animated document is at least one of a credit-card statement, bank statement, account statement or summary of financial transactions.

3. The method of claim 1, wherein the audio-animated document is in at least one of Hypertext Markup Language (HTML) format and a Portable Document Format (PDF) format.

4. The method of claim 1, wherein the transactional activities comprise at least one of financial transactions, social-media transactions, and web-based transactions.

5. The method of claim 1, wherein generating the playback text comprises concatenating or linking the set of phrases and the data.

6. The method of claim 1, wherein the set of rules is associated with the transactional activities or a spending pattern over the pre-defined time interval.

7. The method of claim 1, wherein providing the one or more audio files comprising converting the playback text by using at least one of a Text-to-Speech converter and speech synthesis techniques.

8. The method of claim 1, wherein the audio-animated document comprises a placeholder linked with a sub-set of the data, at least one image of the one or more images, and at least one audio file of the one or more audio files.

9. The method of claim 1, wherein the data, the one or more audio files, and the one or more images represent an analytical summary of the transactional activities.

10. The method of claim 9, wherein the one or more images comprise at least one of a pie chart, a bar chart, a line chart, an advertisement, a marketing or promotional campaign.

11. A system for generating an audio-animated document, the system comprising:
a processor; and
a memory storing processor-executable instructions comprising instructions to:
obtain an extensible markup language (XML) file from a database, wherein the XML file comprises data corresponding to transactional activities over a pre-defined time interval;
identify a set of phrases and one or more images from a resource library based on the XML file;
generate a playback text using the set of phrases, the one or more images, the data, and a set of rules;
provide one or more audio files corresponding to the playback text; and
generate the audio-animated document based on the data, the one or more images, and the one or more audio files.

12. The system of claim 11, wherein the audio-animated document comprises a placeholder linked with a sub-set of the data, at least one image of the one or more images, and at least one audio file of the one or more audio files.

13. The system of claim 12, the instructions further comprising instructions to play the one or more audio files and the one or more images after receiving a selection of the placeholder from a plurality of placeholders.

14. A non-transitory computer program product having embodied thereon computer program instructions for generating an audio-animated document, the instructions comprising instructions for:
obtaining an extensible markup language (XML) file from a database, wherein the XML file comprises data corresponding to transactional activities over a time interval;
identifying a set of phrases and one or more images from a resource library based on the XML file;
generating a playback text using the set of phrases, the one or more images, the data, and a set of rules;
providing one or more audio files corresponding to the playback text; and
generating the audio-animated document based on the data, the one or more images, and the one or more audio files.
